(19) United States
(12) Patent Application Publication
(10) Pub. No.: US 2020/0023506 A1
(43) Pub. Date: Jan. 23, 2020

(54) MOTOR HOUSING EXHAUST AIR SYSTEM

(71) Applicant: Stanley Black & Decker, Inc., New Britain, CT (US)

(72) Inventors: Michael JUSTIS, Towson, MD (US); Daniel HEGARTY, Baltimore, MD (US); William SPANN, Elkridge, MD (US)

(21) Appl. No.: 16/042,649

(22) Filed: Jul. 23, 2018

(51) Int. Cl. B25F 5/00; B25B 21/00

(52) U.S. Cl. CPC B25F 5/008; B25B 21/004

(57) ABSTRACT

In a pneumatic-powered tool, exhaust air may be discharged radially from an air driven motor into a motor chamber. In the motor chamber, the exhaust air may follow a flow path around a periphery of the air driven motor, and be discharged into an exhaust chamber. From the exhaust chamber, the exhaust air may be discharged from the tool in a radial direction. A plurality of exhaust slots may be defined in a peripheral wall of the motor chamber, at a portion of the motor chamber that is adjacent to the exhaust chamber. The plurality of exhaust slots may guide exhaust air from the motor chamber into the exhaust chamber. A guide surface of the exhaust chamber may guide air out of the exhaust chamber in an axial direction.

### FIELD

This document relates, generally, to an exhaust system, and in particular, to an exhaust air system for a pneumatic tool.

### BACKGROUND

Powered tools, and in particular, pneumatic tools, may be driven by compressed air provided by a compressed air source. An operation mode of the pneumatic tool, such as, for example, operation in a forward mode or a reverse mode, may be controlled by a direction of the flow of compressed air through the pneumatic tool. Efficient and effective control of the flow of the compressed air through the pneumatic tool may enhance performance of the tool, and may simplify use of the tool.

Problems inherent in many powered ratcheting tools are limitations to the power output that is generated by a motor and due in large part to the size of the motor contained within the tool's housing. Standard pneumatic powered ratchets have a motor capacity that is generally based on having two housings, one to contain internal tool components and another for directing air flow. Having two housings limits the space available for components that can be contained within the housing and the operation of air flow in the pneumatic tool, without increasing overall size of the tool.

Other problems found in powered ratchets generally include connecting the tool housing to other tool parts, such as attaching the body of the tool housing to a ratchet head through internal threads on body of tool, coupled through externally threaded intermediary connecting part that is housed within the body of the tool. This connection method takes up space in the interior of a tool housing and limits the type, number, and size of tool components that can be contained within the tool housing. Therefore, a need exists for a motor housing exhaust air system.

### SUMMARY

In one aspect, a pneumatic-powered tool may include a first housing, a motor chamber defined in the first housing, an exhaust chamber defined in the first housing, a motor assembly installed in the motor chamber, a discharge space defined between the motor assembly and the motor chamber, at least one exhaust air channel guiding exhaust air, discharged in a radial direction or an axial direction from the motor assembly, into the discharge space, at least one exhaust slot guiding exhaust air from the discharge space into the exhaust chamber, and an exhaust air outlet guiding exhaust air out of the exhaust chamber in a radial direction or an axial direction for discharge from the tool.

In some implementations, the first housing may include a coupling interface. The coupling interface may be configured for joining a second housing to the first housing.

In some implementations, the first housing comprises an externally threaded portion of the first housing configured for threaded coupling to at least one other housing.

In some implementations, the first housing may include the motor chamber, the at least one exhaust slot, and the at least one exhaust air channel.

In another aspect, a first unitary housing for a pneumatic-powered tool may include a motor chamber defined in an inner portion of the first unitary housing, an exhaust chamber defined at an outer peripheral portion of the first unitary housing, at least one exhaust slot guiding exhaust air, discharged in a radial direction or an axial direction from a motor assembly received in the motor chamber, from the motor chamber into the exhaust chamber, and an exhaust air outlet guiding exhaust air out of the exhaust chamber in a radial direction or an axial direction for discharge from the first unitary housing.

This implementation of the invention, in particular, may be desired because the single unitary housing may allow for a larger or smaller tool size as the interior housing capacity can be adjusted to account for different sized internal components. This implementation may have an advantage in providing a motor housing that has increased internal volume for a motor, while not increasing external size of the housing and still providing the function of a typical exhaust air system, or maintaining the size of a motor while decreasing external size of housing and still providing the function of a typical exhaust air system. In this implementation, the housing can contain a bigger motor that can permit the tool to produce an increased power output while also remaining substantially the same size as a comparable tool that a smaller motor.

This implementation of the invention may also be desired, in particular, because the housing includes an external threaded interface on an outer peripheral of the housing. This implementation with the coupling interface increases interior space over standard pneumatic tools and may allow for additional tool components in the interior space, such as a larger motor for increased tool power output, or larger exhaust slots or exhaust channel for increased air flow. This implementation may have an advantage to couple with other tool parts in its attachment mechanism, such as a ratchet head, to body of the tool housing through external threads on tool housing, and an intermediary connecting part, that is internally threaded, located externally to the tool housing, allowing for maximal space internal to the tool housing to be used for tool components. This implementation may allow for maximum space within cavity of ratchet head or motor housing, while maintaining structural integrity under high momentary loading, allowing maximum space for transmission and clutch components, and executing exhaust design that allows for reduced overall tool size or larger motor.

This implementation of the invention, in particular, may also be desired as it provides many of the same exhaust functionality as other pneumatic tools but allows for a reduction in material use, e.g. such as a thickness of a housing wall, while still providing structural integrity and proper exhaust discharge for the tool.

The terminology used herein is for the purpose of describing implementations or embodiments only and is not intended to be limiting of the invention. As used herein, the singular forms, “a”, “an” and “the” are intended to include the plural forms as well, unless the context clearly indicates otherwise. It will be further understood that the root terms “can”, “include”, “can include”, “may”, and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein “connected”, “coupled” or “attached” includes operation or physical, whether direct or indirect, affixed or coupled, as for example, the housing 105 may include a first housing 110 coupled to a second head 120 at a threaded interface 130. Thus, unless specified, “connected”, “coupled” or “attached” is intended to embrace any operationally functional connection.

As used herein “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

The details of one or more implementations are set forth in the accompanying drawings and the description below. Other features will be apparent from the description and drawings, and from the claims.

### BRIEF DESCRIPTION OF THE DRAWINGS

FIG. 1A is a side view of an exemplary pneumatic-powered tool, and FIG. 1B is a partial perspective view of the exemplary pneumatic-powered tool shown in FIG. 1A, in accordance with implementations described herein.

FIG. 2A is a side view of a motor housing portion of an exemplary pneumatic-powered tool, and FIG. 2B is a perspective view of the motor housing portion of the exemplary tool shown in FIG. 2A, in accordance with implementations described herein.

FIGS. 2C and 2D are cross-sectional views of the motor housing portion of the exemplary pneumatic-powered tool shown in FIGS. 2A and 2B, in accordance with implementations described herein.

FIG. 2E is a front view of the motor housing portion of the exemplary pneumatic-powered tool shown in FIGS. 2A and 2B, in accordance with implementations described herein.

FIG. 3A is a cutaway perspective view the motor housing portion of the exemplary pneumatic-powered tool shown in FIGS. 2A and 2B, at an interim fabrication point, in accordance with implementations described herein.

FIG. 3B is a cutaway perspective view the motor housing portion of the exemplary pneumatic-powered tool shown in FIGS. 2A and 2B, post-fabrication, in accordance with implementations described herein.

### DETAILED DESCRIPTION

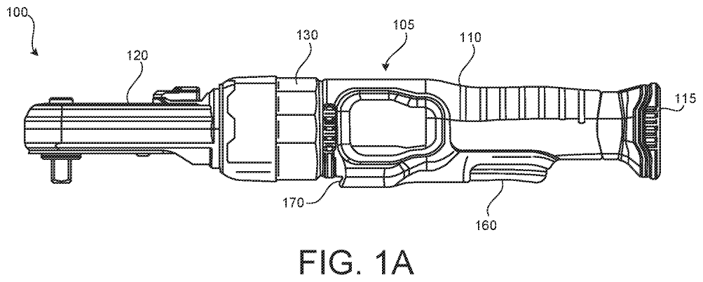

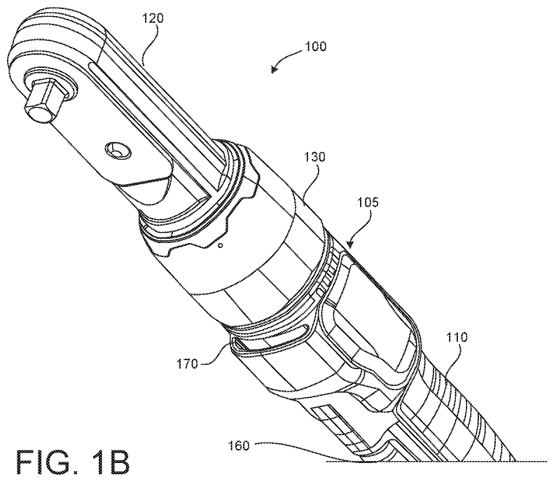

An example implementation of a pneumatic-powered tool 100 is shown in FIGS. 1A and 1B. The example tool 100 illustrated in FIGS. 1A and 1B is a handheld pneumatic-powered ratcheting tool, simply for ease of discussion and illustration. However, the principles to be described herein may be applied to other types of pneumatic tools that include an air driven motor received in a housing.

As shown in FIGS. 1A and 1B, the example tool 100 may include a housing 105. In some implementations, the housing 105 may include a housing 110 coupled to a second housing 120 at a threaded interface 130. For example, in some implementations, the threaded interface 130 may include a threaded clamping nut 130 that couples the housing 110 and the second housing 120, allowing the coupling to be externally threaded. This type of coupling may maintain structural integrity of the tool 100, and of the coupling of the first and second housings 110, 120, allowing the housing 105 to withstand relatively high loading. This type of coupling may also allow for the internal volume of the housing 105 in the area of the interface 130 to be maximized. The housing 110 may define a handle portion of the tool 100, to be grasped by a user for operation of the tool 100. In some implementations, an air powered motor (not shown in FIGS. 1A-1B) may be received in the housing 110. Thus, in some implementations, the housing 110 may be referred to as a motor housing 110. Output mechanism driving components (not shown in FIGS. 1A-1B) may be received in the second housing 120. A supply of power, for example, pneumatic power, or compressed air, to operate the tool 100 may be controlled through selective operation of a trigger 160 provided, for example, on a portion of the motor housing 110. A compressed air inlet 115 may be included, for example, at a first end portion of the motor housing 110, to introduce compressed air, provided from an external source, into the tool 100. As shown in more detail in FIG. 1B, an exhaust air outlet 170 may be included, for example, at a second end portion of the motor housing 110. Exhaust air may be discharged from the air driven motor in a radial direction. This exhaust air may be discharged through the exhaust air outlet 170 in an axial direction, toward a forward end portion of the tool 100.

Some pneumatic-powered tools having an air driven motor may include a discharge component, such as, for example, a discharge sleeve, fitted on, or over, the housing. The discharge component, or discharge sleeve, may direct radially discharged exhaust air from the motor out of the tool, in a radial direction. This discharge component may increase overall size of the tool in the area of the motor, and/or may impact (i.e., decrease) a volume available to accommodate the motor, potentially decreasing the size and/or output power of the motor that can be accommodated in the available space.

An exhaust air outlet, in accordance with implementations described herein, may direct exhaust air, discharged in a radial direction from the air motor received within the housing, in an axial direction, toward a forward portion of the tool, rather than radially outward from the tool. The orientation of the exhaust air outlet, together with an internal geometry of the exhaust air outlet and adjacent exhaust chamber, may provide for a change in the flow direction of discharge exhaust air (i.e., from a radial air flow direction as it is discharged from the motor, to an axial air flow direction as it is discharged from the tool), and the subsequent forward discharge of the exhaust air. In directing the exhaust air in this manner, the exhaust air may travel around a body of the motor, within the housing, thus cooling the motor prior to being discharged from the housing. In some implementations, this longer discharge path, and change in direction (i.e., from a radial air flow direction to an axial air flow direction), and/or an expanding volume of the discharge chamber, may provide for audible noise reduction. An exhaust air outlet, in accordance with implementations described herein, may be defined by a corresponding portion of the housing, rather than as a separate discharge component coupled to the tool. In other words, an exhaust air outlet, in accordance with implementations described herein, may be formed as an integral portion of the housing, thus eliminating the need for a separate component to direct discharged exhaust air out of the tool. This may reduce an overall size of the tool, and/or may allow a larger diameter motor to be accommodated within the housing, without increasing the overall size of the tool.

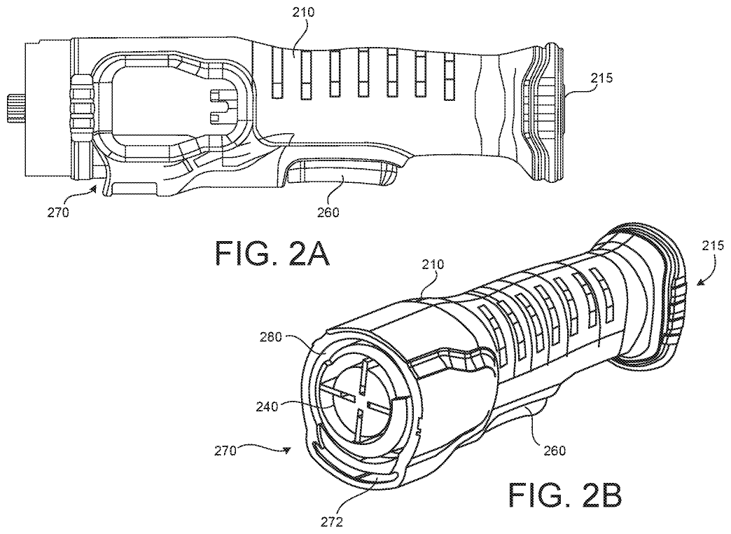

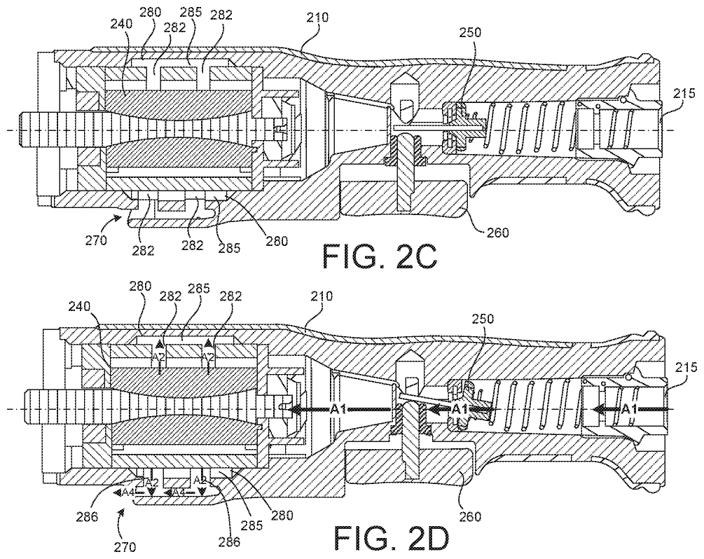

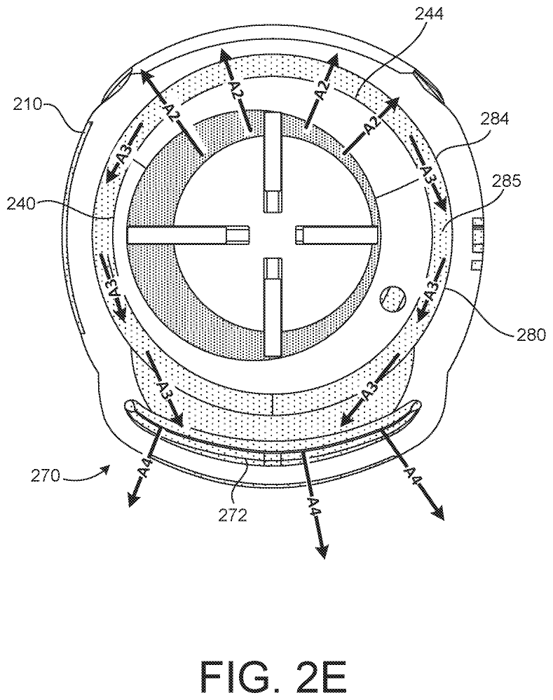

FIGS. 2A and 2B illustrate a motor housing portion of an exemplary pneumatic-powered tool, and FIGS. 2C and 2D are cross-sectional views of the exemplary motor housing portion of the exemplary pneumatic-powered tool shown in FIGS. 2A and 2B, in accordance with implementations described herein. FIG. 2E is a front view of the motor housing portion of the exemplary pneumatic-powered tool shown in FIGS. 2A and 2B, in accordance with implementations described herein. In the cross-sectional view shown in FIG. 2C, a trigger 260 is in an unactuated state, such that a supply of compressed air to an air motor assembly 240 received in a housing 210 is suspended. In the cross-sectional view shown in FIG. 2D, the trigger is in an actuated state, or depressed, to allow compressed air to flow from an external source, through an air inlet 215 to an air motor assembly 240, and to discharge through an exhaust air outlet 270. FIGS. 2D and 2E illustrate airflow through the motor housing portion of the exemplary pneumatic-powered tool, and discharge of exhaust air from the motor housing portion of the exemplary pneumatic-powered tool, in accordance with implementations described herein.

As shown in FIGS. 2C and 2D, a valve 250 may be actuated, or opened, in response to actuation, or depression, of the trigger 260. The opening of the valve 250 may allow compressed air to flow from an external source, into the housing 210 through the air inlet 215, and into the motor assembly 240, as illustrated by the arrows A1 in FIG. 2D, to provide pneumatic power, or air power, to the motor assembly 240. As the motor assembly 240 operates, or rotates, or turns, in response to the application of pneumatic power, exhaust air is radially discharged from the motor assembly 240, as illustrated by the arrows A2 in FIGS. 2D and 2E. The exhaust air may be radially discharged from the motor assembly 240 through air exhaust channels 282, and into a motor chamber 280 surrounding the motor assembly 240. In particular, the exhaust air may be radially discharged from the motor assembly 240 into a discharge space 285 in the motor chamber 280, defined between a peripheral wall 284 (for example, an inner peripheral wall portion) of the motor chamber 280 and a peripheral wall 244 (for example, an outer peripheral wall portion) of the motor assembly 240. The exhaust air may flow through the discharge space 285 in the motor chamber 280, essentially circulating around the motor assembly 240, or circumferentially around the motor assembly 240 (providing cooling to the motor assembly 240), as illustrated by the arrows A3 in FIG. 2E. After flowing through the discharge space 285 in the motor chamber 280, the exhaust air may flow into an exhaust chamber 272. From the exhaust chamber 272, the exhaust air may be discharged through the exhaust air outlet 270, in the direction of the arrows A4.

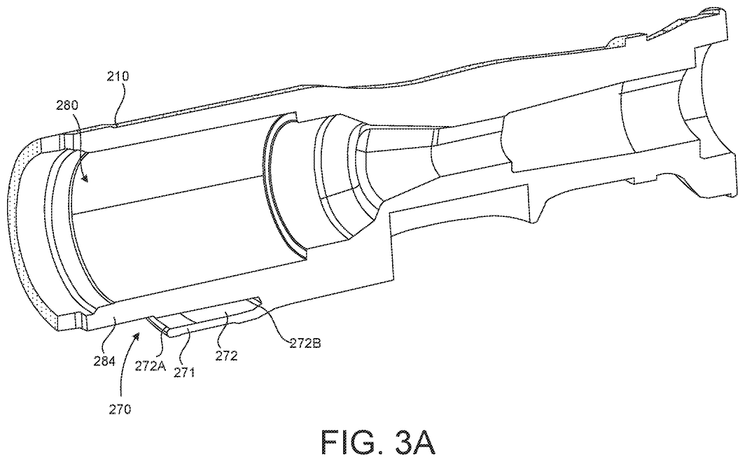

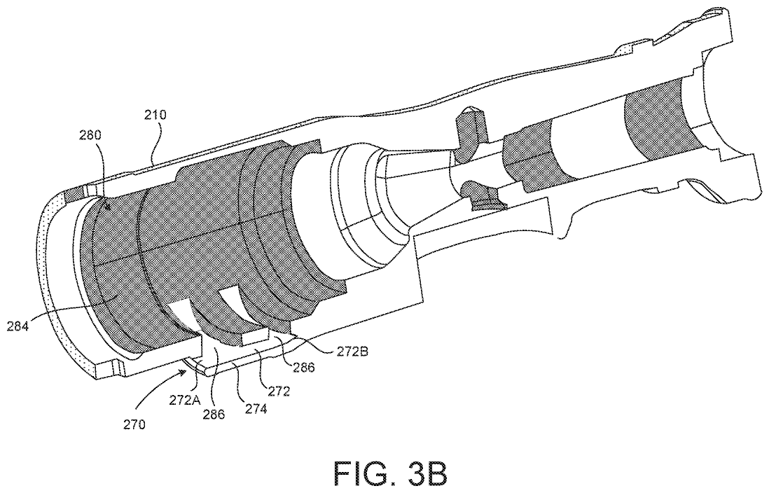

In a pneumatic-powered tool, in accordance with implementations described herein, an air flow path may extend from the air driven motor assembly 240, through the discharge space 285 in the motor chamber 280, into the exhaust chamber 272, and out through the exhaust air outlet 270. Along this air flow path, the flow of discharge air may be guided by the respective components defining the flow path. That is, the exhaust air may flow in a radial direction as it is discharged from the motor assembly 240, through the exhaust channels 282 and into the discharge space 285 in the motor chamber 280. In the discharge space 285 of the motor chamber 280, the exhaust air may flow, substantially circumferentially, toward the exhaust chamber 272. One or more exhaust slots 286, formed in the peripheral wall 284 of the motor chamber 280, may guide the air into the exhaust chamber 272, where the exhaust air flows in a radial direction for discharge through the exhaust air outlet 270. An internal geometry, or contouring, of the motor chamber 280, the exhaust chamber 272, and the one or more exhaust slots 286, may guide this change in air flow direction along the exhaust air flow path. This will be described in more detail with respect to FIGS. 3A and 3B.

FIGS. 3A and 3B are cutaway perspective views of the motor housing portion of the exemplary pneumatic-powered tool shown in FIGS. 2A and 2B, with the motor assembly 240 removed so that an inner circumferential portion of the motor chamber 280 is visible. In particular, the cutaway view shown in FIG. 3A illustrates the exemplary motor housing 210 as a single component, for example, a single cast housing 210, at an interim fabrication point. At the interim fabrication point shown in FIG. 3A, the motor chamber 280 remains separated from the exhaust chamber 272. That is, at the interim fabrication point shown in FIG. 3A, the peripheral wall 284 of the motor chamber 280 forms a barrier between, or separates, the motor chamber 280 and the exhaust chamber 272, such that there would be no air flow between the motor chamber 280 and the exhaust chamber 272. FIG. 3B illustrates the exemplary motor housing 210 after a plurality of air exhaust slots 286 have been machined into the peripheral wall 284 of the motor chamber 280. The fabrication of the plurality of air exhaust slots 286 in the peripheral wall 284 of the motor chamber 280 provides for air flow communication between the motor chamber 280 and the exhaust chamber 272. This air flow communication allows exhaust air that has been radially discharged from the motor assembly 240 into the discharge space 285 in the motor chamber 280 to circulate around the periphery of the motor assembly 240, as shown in FIG. 2E, to flow into the exhaust chamber 272 through the exhaust slots 286, for discharge through the exhaust air outlet 270.

That is, the plurality of exhaust slots 286 may guide exhaust air from the motor chamber 280 into the exhaust chamber 272 for discharge. A shape and/or a position and/or a contour of the air exhaust channels 282 may guide the radial exhaust of air from the motor assembly 240 into the discharge space 285 in the motor chamber 280. A shape and/or a contour of the peripheral wall 284 of the motor chamber 280 and/or the peripheral wall 244 of the motor assembly 240 (defining the discharge space 285) may guide the flow of exhaust air through the motor chamber 280, around the motor assembly 240, and toward the exhaust slots 286. A shape and/or a contour and/or a position of the exhaust slots 286 may facilitate, or guide, the flow of air from the motor chamber 280 into the exhaust chamber 272. In some implementations, the exhaust slots 286 may be formed at a position in the peripheral wall 284 of the motor chamber 280 that is somewhat opposite, or separated from, the exhaust channels 282 to provide for as much air flow as possible along the periphery of the motor assembly 240. As the exhaust air is introduced into the discharge chamber 272 and encounters an inner wall portion 271 of the exhaust chamber 272, the geometry of the exhaust chamber 272 may guide the flow of the exhaust air, or change the flow direction of the exhaust air, so that the exhaust air flows in an axial direction out of the exhaust chamber 272 through the exhaust air outlet 270.

More specifically, as shown in FIGS. 2B-2E, 3A and 3B, the exhaust air outlet 270 may be formed as an opening at a first end portion 272A of the exhaust chamber 272. A second end portion 272B of the exhaust chamber 272, opposite the first end portion 272A, may be closed. Similarly, a first side portion 272C and a second side portion 272D of the exhaust chamber 272 may be closed. The inner wall portion 271 of the exhaust chamber 272 may extend between the first and second end portions 272A, 272B of the exhaust chamber 272, and between the first and second side portions 272C, 272D of the exhaust chamber 272. As the exhaust slots 286 are positioned opposite the inner wall portion 271 of the exhaust chamber 272, exhaust air introduced into the exhaust chamber 272 (from the motor chamber 280 through the exhaust slots 286) may encounter, or impinge on, the inner wall portion 217 of the exhaust chamber 272. This contact with the inner wall portion 271 of the exhaust chamber 272 may cause the flow of exhaust air to change direction, and the exhaust air to flow in the axial direction, toward the exhaust air outlet 270, as described above

In the exemplary implementation illustrated in FIGS. 2C, 2D and 3B, a plurality of exhaust slots 286 (in particular, two exhaust slots 286) are defined in the peripheral wall 284 of the motor chamber 280, simply for ease of discussion and illustration. In some implementations, more, or fewer, exhaust slots 286 may be formed in the peripheral wall 284 of the motor chamber 280, and/or in a different arrangement than illustrated. Similarly, in the exemplary implementation illustrated in FIGS. 2C and 2D, the motor assembly 240 includes a plurality of exhaust channels 282 (in particular, two exhaust channels 282), simply for ease of discussion and illustration. In some implementations, more, or fewer, exhaust channels 282 may be provided, and/or in a different arrangement than illustrated.

In a pneumatic-powered tool, in accordance with implementations described herein, an arrangement of one or more air exhaust channels 282, one or more air exhaust slots 286, and an exhaust chamber 272, may allow air discharged from the motor assembly 240 in the radial direction to be discharged from the tool in the axial direction. As noted above, the orientation of the exhaust air outlet 270, together with the arrangement of the one or more air exhaust slots 286 relative to the motor chamber 280, the exhaust chamber 272 and the exhaust air outlet 270, may provide for a change in the flow direction of discharge exhaust air, and the subsequent forward discharge of the exhaust air. In directing the exhaust air in this manner, the exhaust air may circulate around an outer periphery of the motor assembly 240, thus cooling the motor assembly 240 prior discharge. As also noted above, the relatively longer discharge path (compared to a direct radial discharge of exhaust air), and change in direction (i.e., from a radial air flow direction to an axial air flow direction), and/or an expanding volume of the discharge chamber 272, may provide for audible noise reduction during operation of the tool.

In a pneumatic-powered tool, in accordance with implementations described herein, the exhaust chamber 272 may be defined by a protruded portion 274 of the housing 210, or an exhaust scoop 274 defined in the housing 210. In some implementations, the exhaust scoop 274 may be integrally formed with the housing 210, to allow for a single piece construction of the housing 210 and the exhaust chamber 272. As noted above, this single piece, or integral construction, together with the one or more exhaust slots 286 formed in the peripheral wall 284 of the motor chamber 280, may eliminate the need for a separate component to direct discharged exhaust air out of the tool, and/or may reduce an overall size of the tool, and/or may allow a larger diameter motor assembly 240 to be accommodated within the housing 210, without increasing the overall size of the tool.

While certain features of the described implementations have been illustrated as described herein, many modifications, substitutions, changes and equivalents may occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A pneumatic powered tool, comprising:
a housing;
a motor chamber defined in the housing;
an exhaust chamber defined in the housing;
a motor assembly installed in the motor chamber;
a discharge space defined between the motor assembly and the motor chamber;
at least one exhaust air channel guiding exhaust air, discharged in a radial direction or an axial direction from the motor assembly, into the discharge space;
at least one exhaust slot guiding exhaust air from the discharge space into the exhaust chamber; and
an exhaust air outlet guiding exhaust air out of the exhaust chamber in a radial direction or an axial direction for discharge from the tool.

2. The tool of claim 1, wherein the housing comprises a coupling interface, the coupling interface configured for joining a second housing to the housing.

3. The tool of claim 1, wherein the housing comprises a protruded outer peripheral portion, the protruded outer peripheral portion of the housing having the exhaust chamber formed therein.

4. The tool of claim 3, wherein the exhaust air outlet is formed as an opening at a first end portion of the exhaust chamber, wherein a second end portion of the exhaust chamber, a first side portion of the exhaust chamber, and a second side portion of the exhaust chamber are closed so as to guide exhaust air toward the exhaust air outlet.

5. The tool of claim 4, wherein an inner wall portion of the exhaust chamber extends from the first end portion to the second end portion of the exhaust chamber, and from the first side portion to the second side portion of the exhaust chamber, and is positioned opposite the at least one exhaust slot.

6. The tool of claim 5, wherein exhaust air flowing into the exhaust chamber through the at least one exhaust slot flows into contact with the inner wall portion of the exhaust chamber, and wherein the inner wall portion of the exhaust chamber is positioned so as to change a flow direction of the exhaust air.

7. The tool of claim 6, wherein the inner wall portion of the exhaust chamber is positioned so as to direct the flow of exhaust air toward the exhaust air outlet.

8. The tool of claim 1, wherein the at least one exhaust slot comprises a plurality of exhaust slots formed in a wall of the motor chamber and the plurality of exhaust slots comprise a plurality of openings arranged in parallel in a peripheral wall of the motor chamber, at a position along the peripheral wall of the motor chamber corresponding to the exhaust chamber, such that the plurality of exhaust slots provide for air flow between the discharge space in the motor chamber and the exhaust chamber.

9. The tool of claim 1, wherein the at least one exhaust slot comprises at least one circumferentially arranged opening formed in a wall of the motor chamber.

10. The tool of claim 1, wherein the discharge space extends around outer peripheral portions of the motor assembly.

11. The tool of claim 1, wherein the housing is a single piece cast housing, and the motor chamber and the exhaust chamber are integrally formed in the housing.

12. The tool of claim 1, wherein the housing comprises an externally threaded portion of the housing configured for threaded coupling to at least one other housing.

13. The tool of claim 1, wherein the housing comprises the motor chamber, the at least one exhaust slot, and the at least one exhaust air channel.

14. A unitary housing for a pneumatic-powered tool, comprising:
a motor chamber defined in an inner portion of the unitary housing;
an exhaust chamber defined at an outer peripheral portion of the unitary housing;
at least one exhaust slot guiding exhaust air, discharged in a radial direction or an axial direction from a motor assembly received in the motor chamber, from the motor chamber into the exhaust chamber; and
an exhaust air outlet guiding exhaust air out of the exhaust chamber in a radial direction or an axial direction for discharge from the unitary housing.

15. The unitary housing of claim 14, wherein the exhaust air outlet is formed as an opening at a first end portion of the exhaust chamber, and wherein a second end portion of the exhaust chamber, a first side portion of the exhaust chamber, and a second side portion of the exhaust chamber are closed so as to guide exhaust air toward the exhaust air outlet.

16. The unitary housing of claim 15, wherein an inner wall portion of the exhaust chamber extends from the first end portion to the second end portion of the exhaust chamber, and from the first side portion to the second side portion of the exhaust chamber, and is positioned opposite the at least one exhaust slot.

17. The unitary housing of claim 16, wherein exhaust air flowing into the exhaust chamber through the at least one exhaust slot flows into contact with the inner wall portion of the exhaust chamber, and wherein the inner wall portion of the exhaust chamber is positioned so as to change a flow direction of the exhaust air.

18. The unitary housing of claim 17, wherein the inner wall portion of the exhaust chamber is positioned so as to direct the flow of exhaust air in a radial direction or an axial direction of the unitary housing, toward the exhaust air outlet.

19. The unitary housing of claim 14, wherein the at least one exhaust slot comprises at least one circumferentially arranged opening formed in a peripheral wall of the motor chamber.

20. The unitary housing of claim 14, wherein the at least one exhaust slot comprises a plurality of exhaust slots defined by a plurality of openings arranged in parallel in the peripheral wall of the motor chamber, at a position along the peripheral wall of the motor chamber corresponding to the exhaust chamber, such that the plurality of exhaust slots provide for air flow communication between the motor chamber and the exhaust chamber.

21. The unitary housing of claim 14, wherein the unitary housing is a single piece cast housing, and the motor chamber and the exhaust chamber are integrally formed in the unitary housing.

22. The unitary housing of claim 14, wherein the unitary comprises an externally threaded portion of the unitary housing configured for threaded coupling to at least one other housing.

23. The unitary housing of claim 14, wherein the unitary housing comprises the motor chamber, the at least one exhaust slot, and the at least one exhaust air channel.
